(19) United States
(12) Patent Application Publication
(10) Pub. No.: US 2013/0030099 A1
(43) Pub. Date: Jan. 31, 2013

(54) CARBON BLACK COMPOSITION AND USAGE THEREOF

(71) Applicant: Kazufumi OMURA, Minami-ashigara-shi (JP)

(72) Inventor: Kazufumi OMURA, Minami-ashigara-shi (JP)

(73) Assignee: FUJIFILM Corporation, Tokyo (JP)

(21) Appl. No.: 13/560,578

(22) Filed: Jul. 27, 2012

(30) Foreign Application Priority Data
Jul. 29, 2011 (JP) 2011-166408
Jul. 24, 2012 (JP) 2012-163183

(51) Int. Cl. C08K 5/315; C09D 127/06; C09D 5/00; C09D 175/04; C08L 75/04; C08L 27/06

(52) U.S. Cl. 524/205; 106/476

(57) ABSTRACT

An aspect of the present invention relates to a carbon black composition, which comprises carbon black; an alkane nitrile; and at least one organic solvent selected from the group consisting of methyl ethyl ketone and cyclohexanone.

### CROSS-REFERENCE TO RELATED APPLICATIONS

This application claims the benefit of priority under 35 USC 119 to Japanese Patent Application No. 2011-166408 filed on July 29 and Japanese Patent Application No. 2012-163183 filed on Jul. 24, 2012, which are expressly incorporated herein by reference in their entirety.

### BACKGROUND OF THE INVENTION

1. Field of the Invention

The present invention relates to a carbon black composition, and more particularly, to a carbon black composition capable of achieving a highly dispersed state of carbon black in solvent.

The present invention further relates to a carbon black-containing coating film obtained from the above carbon black composition.

2. Discussion of the Background

Carbon black is employed as a coloring material, electrically conductive material, filler and the like in various fields such as print ink, paints, cosmetics, and batteries. In the field of magnetic recording, carbon black is widely added to magnetic layers, nonmagnetic layers, backcoat layers, and the like to prevent static electricity, reduce the coefficient of friction, impart a light-blocking property, enhance film strength, and the like in magnetic tapes and disks.

As set forth above, carbon black is a useful material that is employed in various fields. However, it forms a high-order structure, known as a “structure,” that has an aggregating property in solvent. The more minute the particles, the more pronounced the above property becomes, entailing various problems. For example, in particulate magnetic recording media, when carbon black aggregates in the coating liquid, the smoothness of the coatings of magnetic layers and the like that are formed by coating and drying the coating liquid on a support is greatly compromised. When carbon black aggregates in a print ink, color irregularities and degradation of color tone result.

Thus, various attempts have been made to enhance the dispersion of carbon black in solvents. For example, in the field of magnetic recording, the use of various aromatic compounds as dispersing agents to increase the dispersion of carbon black has been proposed (for example, see
Japanese Patent No. 4149648 or English language family members US2002/064687A1 and U.S. Pat. No. 6,653,000, Japanese Unexamined Patent Publication (KOKAI) No. 2002-140813, Japanese Unexamined Patent Publication (KOKAI) No. 2003-168208, Japanese Unexamined Patent Publication (KOKAI) No. 2005-222630, Japanese Unexamined Patent Publication (KOKAI) No. 2005-222631, Japanese Unexamined Patent Publication (KOKAI) No. 2006-185525, Japanese Unexamined Patent Publication (KOKAI) No. 2006-185526, Japanese Unexamined Patent Publication (KOKAI) No. 2009-224009, and Japanese Patent No. 2602273, which are expressly incorporated herein by reference in their entirety.

As set forth above, carbon black is widely employed in various fields, and there is constant demand for enhanced dispersion (aggregation prevention). However, it has the special property of forming a structure. Thus, it is not easy to enhance the dispersion of carbon black. The dispersed state of carbon black that is achieved by conventional methods—in the field of magnetic recording, for example, where a high degree of coating smoothness is demanded to achieve higher density recording—is not necessarily adequate.

### SUMMARY OF THE INVENTION

An aspect of the present invention provides for a composition (carbon black composition) in which carbon black is highly dispersed in a solvent.

To obtain the above composition, the present inventor conducted extensive research. As a result, he discovered that in a system containing an alkane nitrile and a solvent selected from the group consisting of methyl ethyl ketone and cyclohexanone, the dispersion of carbon black was greatly enhanced. The present inventor presumed the following in that regard.

With regard to carbon black, the fact that a hydrophilic moiety comprising a hydroxyl group or a carboxyl group and a hydrophobic moiety comprising carbon are present on the surface of carbon black, and the fact that the hydrophobic moiety comprising carbon is an aromatic ring comprising a graphite structure are known (for example, see Adhesive Technology, Vol. 30, No. 4 (2011), Vol. 101, p. 5, FIG. 1.7). It is thought that the dispersion of carbon black is enhanced by covering the hydrophilic moiety or the hydrophobic moiety with a compound having a unit with affinity for either the hydrophilic moiety or the hydrophobic moiety. However, carbon black ends up forming a structure in solvent before the hydrophilic moiety or hydrophobic moiety is covered, so that even when a compound having a unit with affinity for either of the moieties is added, it tends not to enhance dispersion by blocking the formation of the structure.

By contrast, by employing in combination a solvent selected from the group consisting of methyl ethyl ketone and cyclohexanone, which are solvents in which carbon black tends not to form a structure, and the alkane nitrile having affinity with the hydrophilic moiety in the above system discovered by the present inventor, it is thought that the alkane nitrile covers the hydrophilic moiety of the carbon black surface, blocking the formation of the structure. The present inventor further presumed that as a result, it was possible to obtain a carbon black composition in which carbon black was highly dispersed.

The present invention was devised on the basis of the above knowledge.

An aspect of the present invention relates to a carbon black composition, which comprises carbon black; an alkane nitrile; and at least one organic solvent selected from the group consisting of methyl ethyl ketone and cyclohexanone.

In an embodiment, the alkane nitrile is acetonitrile.

In an embodiment, the carbon black composition further comprises a binder resin.

In an embodiment, the binder resin is selected from the group consisting of a vinyl copolymer and a polyurethane resin.

In an embodiment, the carbon black composition comprises the carbon black in a dispersed state with a particle diameter in liquid as measured by a dynamic light scattering method of equal to or less than 50 nm.

A further aspect of the present invention relates to a carbon black-containing coating film, which has been obtained by drying the above carbon black composition.

The present invention can provide a carbon black composition in which carbon black is highly dispersed in solvent. The carbon black composition of the present invention is useful in coating liquids for particulate magnetic recording media, print inks, and the like.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The carbon black composition of the present invention comprises carbon black; an alkane nitrile; and at least one organic solvent selected from the group consisting of methyl ethyl ketone and cyclohexanone.

As set forth above, the present inventor presumed that by causing carbon black and the alkane nitrile to both be present in the above organic solvent in which structures tend not to form, the alkane nitrile covered the hydrophilic portion of the carbon black, thereby achieving a state of high carbon black dispersion.

The carbon black composition of the present invention will be described in greater detail below. Hereinafter, the “number of carbon atoms” when a substituent is present shall mean the number of carbon atoms in the portion excluding the substituent. Examples of the substituent mentioned below are halogen atoms (such as fluorine atoms, chlorine atoms, and bromine atoms). In the present invention the range indicator “to” shall indicate a range including the numbers before and after it as a minimum value and maximum value, respectively.

The alkyl group in the alkane nitrile (RCN: where R denotes an alkyl group) contained in the carbon black composition of the present invention is a substituted or unsubstituted linear or branched alkyl group that, from the perspective of adsorption to the hydrophilic moiety of the carbon black, is desirably an unsubstituted linear alkyl group with 1 to 6 carbon atoms. That is, desirable specific examples of the alkane nitrile are: acetonitrile, propionitrile, butyronitrile, valeronitrile, and hexanenitrile. Of these, acetonitrile is preferred from the perspective of availability and the dispersion-enhancing effect it has on carbon black.

The carbon black that is contained in the carbon black composition of the present invention is not specifically limited. It can be selected for use based on the application from among various carbon blacks such as furnace black for rubber, thermal for rubber, black for coloring, electrically conductive carbon black, acetylene black. With regard to carbon black suitable for use in the present invention, reference can be made to the Carbon Black Handbook (compiled by the Carbon Black Association, which is expressly incorporated herein by reference in its entirety, for example.

For example, in a particulate magnetic recording medium, carbon black can be mixed into the nonmagnetic layer to achieve the known effect of reducing surface resistivity Rs and optical transmittance, and achieving a desired micro-Vicker's hardness. A lubricant stockpiling effect can also be achieved by incorporating carbon black into the nonmagnetic layer. The specific surface area of the carbon black that is employed in the nonmagnetic layer is normally 50 to 500 m²/g, desirably 70 to 400 m²/g, and the DBP oil absorption capacity is normally 20 to 400 mL/100 g, desirably 30 to 400 mL/100 g. The average primary particle diameter of the carbon black that is employed in the nonmagnetic layer is normally 5 to 80 nm, desirably 10 to 50 nm, and preferably, 10 to 40 nm.

The surface resistance and light transmittance of the backcoat layer can be set low by adding microparticulate carbon black to the backcoat layer of a particulate magnetic recording medium. Since many magnetic recording devices utilize the light transmittance of the tape for an operating signal, adding microparticulate carbon black is particularly effective in such cases. In the microparticulate carbon black that is employed in the backcoat layer, it is desirable for the average primary particle diameter to fall within a range of 5 to 30 nm, the specific surface area to fall within a range of 60 to 800 m²/g, the DBP oil absorption capacity to fall within a range of 50 to 130 mL/100 g, and the pH to fall within a range of 2 to 11.

Reference can be made to paragraphs [0033] to [0053] of Japanese Patent No. 4149648, for example, for details on the above carbon blacks. Reference can also be made to paragraph of Japanese Patent No. 4149648 for details on the carbon black contained in the magnetic layer.

The carbon black composition of the present invention can be employed as a coating composition for forming a particulate magnetic recording medium, or to prepare such a coating composition, by incorporating various optionally added components with the above carbon black.

The above carbon black is also suitable for use as a pigment in print ink. The carbon black composition of the present invention containing such carbon black can be suitably employed as a black ink in various types of printing such as ink-jet printing, offset printing, and gravure printing.

From the perspective of further enhancing the dispersion of carbon black, the alkane nitrile is desirably employed in a proportion of 1 to 50 weight parts, preferably 1 to 20 weight parts, per 100 weight parts of carbon black. For the same reason, the total quantity of solvent relative to carbon black is desirably 100 to 1,000 weight parts per 100 weight parts of carbon black in the carbon black composition of the present invention.

The essential solvent in the carbon black composition of the present invention is selected from the group consisting of methyl ethyl ketone and cyclohexanone. When employing a solvent that is not a member of the essential solvent, it is desirable to cover the surface of the carbon black with the alkane nitrile by mixing the carbon black and alkane nitrile in the above essential solvent in advance. Thus, the carbon black dispersion will be well maintained when the other solvent is added.

Methyl ethyl ketone or cyclohexanone can be employed singly, or a combination in any ratio of methyl ethyl ketone and cyclohexanone can be employed as the essential solvent. Since both methyl ethyl ketone and cyclohexanone have relatively low boiling points and are highly stable, they are solvents that are widely employed in various fields, such as the magnetic recording field, printing field, and cosmetic field. The carbon black composition of the present invention contains these solvents as essential solvents, and is thus highly useful in all of these various fields. That is one advantage afforded by the carbon black composition of the present invention.

The carbon black composition of the present invention can contain solvents other than the above essential solvents. In that case, the essential solvents desirably constitute equal to or more than 50 weight percent, preferably 50 to 95 weight percent, of the total quantity of solvent. Examples of solvents that can be used in combination are ether solvents, ester solvents, ketone solvents, and alcohol solvents. Specific examples of ketone solvents that can be used in combination are acetone, methyl isobutyl ketone, diisobutyl ketone, and isophorone. Examples of alcohol solvents that can be employed in combination are methanol, ethanol, propanol, butanol, isobutyl alcohol, isopropyl alcohol, and cyclohexanol. However, aromatic solvents such as benzene, toluene, and xylene are desirably not employed in combination due to the possibility of promoting the formation of a carbon black structure. When employed in combination, they are desirably kept to less than 5 weight percent of the total quantity of solvent.

One known common method of raising the dispersion of microparticles is the method of covering the surface of the microparticles with binder resin. However, in the carbon black composition of the present invention, by combining the above-described essential solvent and the alkane nitrile, a high state of carbon black dispersion can be achieved without combining the use of a binder resin. Specifically, even when the carbon black composition of the present invention does not contain a binder resin, a state of high dispersion of carbon black with a particle diameter in liquid as measured by the dynamic light scattering method, for example, of equal to or less than 150 nm, desirably equal to or less than 70 nm, and preferably, equal to or less than 50 nm, can be achieved.

In this context, the term “particle diameter in liquid as measured by the dynamic light scattering method” is an index of the state in which the carbon black is present in the carbon black composition of the present invention, that is, the state of dispersion. The lower the value, the better the state of dispersion in a state approximating primary particles without the carbon black undergoing aggregation that is achieved. Measurement by the dynamic light scattering method can be conducted with an LB-500 dynamic light scattering particle size analyzer made by Horiba. The particle diameter in liquid can also be measured by dilution with the liquid that is to be measured to enhance measurement precision. In that case, to further enhance measurement precision, it is desirable to employ a solvent that is contained in the liquid that is to be measured as the diluting solvent, and preferable to use the same solvent as the liquid to be measured.

The carbon black can be dispersed to an even higher degree by incorporating a binder resin into the carbon black composition of the present invention. By combining a binder resin, the carbon black can be dispersed to an extremely high state of dispersion of a particle diameter in liquid of equal to or less than 50 nm, even equal to or less than 40 nm. Regardless of whether or not a binder resin is employed, the lower limit of the particle diameter in liquid is the primary particle diameter or average primarily particle diameter of the carbon black.

Examples of binder resins that can be employed are polyurethane resin, polyester resin, polyamide resin, vinyl chloride resin, acrylic resins obtained by copolymerizing styrene, acrylonitrile, methyl methacrylate, or the like, cellulose resins such as nitrocellulose, epoxy resin, phenoxy resin, and polyvinyl alkyral resins such as polyvinyl acetal and polyvinyl butyral. Of these, vinyl copolymers and polyurethane resins are employed with preference. The binder resin can be employed in a proportion of 1 to 100 weight parts per 100 weight parts of carbon black, for example.

The average particle size of powders such as carbon black in the present invention can be measured by the following method.

Particles of powder are photographed at a magnification of 100,000-fold with a model H-9000 transmission electron microscope made by Hitachi and printed on photographic paper at a total magnification of 500,000-fold to obtain particle photographs. The targeted particle is selected from the particle photographs, the contours of the particle are traced with a digitizer, and the size of the particles is measured with KS-400 image analyzer software from Carl Zeiss. The size of 500 particles is measured. The average value of the particle sizes measured by the above method is adopted as an average particle size of the powder.

The size of a powder (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method. As in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

The average powder size of the powder is the arithmetic average of the above powder size and is calculated by measuring five hundred primary particles in the above-described method. The term “primary particle” refers to a nonaggregated, independent particle.

The carbon black composition of the present invention can be prepared by simultaneously or sequentially mixing the above-described essential solvent, alkane nitrile, and carbon black. To further enhance carbon black dispersion, solvents other than the essential solvent and optional components such as various additives that are selected for use based on the application of the carbon black composition of the present invention are desirably added after mixing the above essential components.

The carbon black composition of the present invention as set forth above is suitable for use in various fields in which a high degree of carbon black dispersion is demanded, such as in particulate magnetic recording media, print ink, paint, cosmetics, and batteries.

The present invention further relates to a carbon black-containing coating film, which has been obtained by drying the carbon black composition of the present invention.

The carbon black composition of the present invention that is set forth above can contain carbon black in a highly dispersed state. Thus, a coating film affording good surface smoothness without surface roughening due to aggregation of carbon black can be obtained by coating and drying the composition on a support, for example. One embodiment of the coating film of the present invention can be employed as a backcoat layer, nonmagnetic layer, magnetic layer, or the like of magnetic recording media. Another embodiment of the coating film of the present invention can be employed in various modes such as antistatic sheets.

### EXAMPLES

The present invention will be described in detail below based on Examples. However, the present invention is not limited to the examples.

### Examples and Comparative Examples of the Carbon Black Composition and Coating Film

### Example 1

A 1.0 weight part quantity of the following carbon black, 0.019 weight part of acetonitrile, 0.41 weight part of vinyl chloride resin (MR104 made by Zeon Corporation), and 0.25 weight part of polyether polyurethane were suspended in a mixed solvent comprised of 12 weight parts of methyl ethyl ketone and 8 weight parts of cyclohexanone. Fifty weight parts of zirconia beads 0.1 mm in diameter (made by Nikkato Corp.) were added to the suspension and dispersed for 15 hours to obtain a carbon dispersion.

Carbon black: #950, made by Mitsubishi Chemical Corp.

Average primary particle diameter: 18 nm

Nitrogen adsorption specific surface area: 260 m²/g

DBP oil absorption capacity: 79 mL/100 g (powder form)

pH: 7.5

Measurement of the Dispersed Particle Diameter by the Method Set Forth Further Below (Particle Diameter in Liquid by the Dynamic Light Scattering Method) revealed a value of 38 nm.

The carbon dispersion was coated using a doctor blade having a gap of 19 μm on a PEN base made by Teijin Co. and left standing for 30 minutes at room temperature to dry, yielding a coating film. The coating film thus prepared had an average roughness as measured by the method set forth below of 1.8 nm.

(1) Method of Measuring Dispersed Particle Diameter (Particle Diameter in Liquid by Dynamic Light Scattering Method)

The carbon dispersion was diluted with the same organic solvent as that employed in dispersion to a solid component concentration of 0.2 weight % (the solid component denoted the combined weight of the carbon black, alkane nitrile, and binder resin).

The average particle diameter as measured with an LB-500 dynamic light scattering particle size analyzer made by Horiba for the diluted liquid obtained was adopted as the dispersed particle diameter. The smaller the dispersed particle diameter, the better the dispersion without aggregation of carbon black indicated.

(2) Method of Surface Roughness Measurement

The surface roughness of the coating film was measured at a scan length of 5 μm by scanning white light interferometry with a NewView 5022 general purpose 3D surface profile analyzer made by Zygo. The object lens was 20×, the intermediate lens was 1.0×, and the measurement viewfield was 260 μm×350 μm. The surface measured was processed with HPF: 1.65 μm and LPF: 50 μm filters to obtain the centerline average surface roughness Ra value.

### Example 2

With the exception that the 0.019 weight part of acetonitrile was changed to 0.038 weight part, a dispersion was prepared by the same operation as in Example 1. The dispersed particle diameter was measured by the above method as 35 nm. A coating was prepared and the average roughness was measured as 1.8 nm by the methods set forth above.

### Comparative Example 1

With the exception that no acetonitrile was employed, a dispersion was prepared by the same operation as in Example 1. The dispersed particle diameter was measured by the above method as 140 nm. A coating film was prepared and the average roughness was measured as equal to or higher than 10 nm by the methods set forth above.

Based on the above results, the combination of an alkane nitrile and a specified solvent permitted the dispersion of carbon black to a high degree, and thus made it possible to form a carbon black-containing coating film of high surface smoothness.

The present invention is useful in various fields such as the magnetic recording field, print field, and cosmetic product field.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A carbon black composition, which comprises:
carbon black;
an alkane nitrile; and
at least one organic solvent selected from the group consisting of methyl ethyl ketone and cyclohexanone.

2. The carbon black composition according to claim 1, wherein the alkane nitrile is acetonitrile.

3. The carbon black composition according to claim 1, which further comprises a binder resin.

4. The carbon black composition according to claim 2, which further comprises a binder resin.

5. The carbon black composition according to claim 3, wherein the binder resin is selected from the group consisting of a vinyl copolymer and a polyurethane resin.

6. The carbon black composition according to claim 4, wherein the binder resin is selected from the group consisting of a vinyl copolymer and a polyurethane resin.

7. The carbon black composition according to claim 1, which comprises the carbon black in a dispersed state with a particle diameter in liquid as measured by a dynamic light scattering method of equal to or less than 50 nm.

8. The carbon black composition according to claim 2, which comprises the carbon black in a dispersed state with a particle diameter in liquid as measured by a dynamic light scattering method of equal to or less than 50 nm.

9. The carbon black composition according to claim 3, which comprises the carbon black in a dispersed state with a particle diameter in liquid as measured by a dynamic light scattering method of equal to or less than 50 nm.

10. The carbon black composition according to claim 4, which comprises the carbon black in a dispersed state with a particle diameter in liquid as measured by a dynamic light scattering method of equal to or less than 50 nm.

11. The carbon black composition according to claim 5, which comprises the carbon black in a dispersed state with a particle diameter in liquid as measured by a dynamic light scattering method of equal to or less than 50 nm.

12. The carbon black composition according to claim 6, which comprises the carbon black in a dispersed state with a particle diameter in liquid as measured by a dynamic light scattering method of equal to or less than 50 nm.

13. A carbon black-containing coating film, which has been obtained by drying a carbon black composition, the carbon black composition comprising:
carbon black;
an alkane nitrile; and
at least one organic solvent selected from the group consisting of methyl ethyl ketone and cyclohexanone.

14. The carbon black-containing coating film according to claim 13, wherein the alkane nitrile is acetonitrile.

15. The carbon black-containing coating film according to claim 13, wherein the carbon black composition further comprises a binder resin.

16. The carbon black-containing coating film according to claim 14, wherein the carbon black composition further comprises a binder resin.

17. The carbon black-containing coating film according to claim 15, wherein the binder resin is selected from the group consisting of a vinyl copolymer and a polyurethane resin.

18. The carbon black-containing coating film according to claim 16, wherein the binder resin is selected from the group consisting of a vinyl copolymer and a polyurethane resin.
